(19) United States
(12) Patent Application Publication
(10) Pub. No.: US 2023/0081020 A1
(43) Pub. Date: Mar. 16, 2023

(54) DRIVING ASSISTANCE DEVICE AND DRIVING ASSISTANCE SYSTEM

(71) Applicant: ISUZU MOTORS LIMITED, Tokyo (JP)

(72) Inventors: Mayumi IWAO, Fujisawa-shi, Kanagawa (JP); Kazuhiko YAMAGUCHI, Fujisawa-shi, Kanagawa (JP); Yoshimune YAMAGISHI, Fujisawa-shi, Kanagawa (JP)

(21) Appl. No.: 17/800,842

(22) PCT Filed: Feb. 15, 2021
(86) PCT No.: PCT/JP2021/005411

§ 371 Date: Sep. 13, 2022

(30) Foreign Application Priority Data
Feb. 19, 2020 (JP) 2020-026463

(51) Int. Cl. B60Q 9/00

(52) U.S. Cl. CPC B60Q 9/00

(57) ABSTRACT

A driving assistance device 1 is provided with: three or more detection units 5a to 5d which are configured to detect a likely-to-be-dozing state in which likelihood that a driver of a vehicle is dozing is high by different indices and at prescribed intervals; a state determination unit 34 which determines that the driver is in a dozing state when the likely-to-be-dozing state is detected by at least two of the detection units; and a warning control unit 36 which causes a warning device 6 to issue a warning when the state determination unit 34 determines that the driver is in the dozing state.

### TECHNICAL FIELD

The present disclosure relates to a driving assistance device and a driving assistance system.

### BACKGROUND ART

From the viewpoint of safety, some vehicles issue a warning when a dozing state of a driver is detected, so as to warn the driver. Various methods have been proposed for detection of a dozing state, and for example, there is a method of capturing an image of a driver and detecting that the driver is in a dozing state when eyes of the driver are closed for a predetermined time or longer.

### CITATION LIST

### Patent Literature

Patent Literature 1: TP 2006-136556 A

### SUMMARY OF INVENTION

### Technical Problem

However, since the dozing state of the driver is detected by a single detection method in the related art, and eyes of a person who is the driver are diverse, a difference in detection accuracy is likely to occur, and it is difficult to appropriately detect the dozing state. As a result, an erroneous warning may be issued.

The present disclosure has been made in view of these points, and an object thereof is to prevent an erroneous warning caused by erroneous determination on a dozing state.

### Solution to Problem

According to one illustrative aspect of the present disclosure, provided is a driving assistance device including: three or more detection units configured to detect a likely state in which likelihood that a driver of a vehicle is dozing is high by different indices and at prescribed intervals; a state determination unit configured to determine that the driver is in a dozing state when the likely state is detected by at least two of the detection units; and a warning control unit configured to cause a warning unit to issue a warning when the state determination unit determines that the driver is in the dozing state.

Further, the state determination unit may be configured to: totalize numerical values indicating detection of the likely state by each of the detection units; and in a case a total value exceeds a threshold value, determine that the driver is in the dozing state.

Further, the warning control unit may be configured to: in a case the total value exceeds a first threshold value, issue a first warning; and in a case the total value exceeds a second threshold value larger than the first threshold value, issue a second warning with a warning level higher than that of the first warning.

Further, the three or more detection units may include: a closed eye detection unit configured to detect the likely state based on an eye-closed state of eyes of the driver; and a vehicle behavior detection unit configured to detect the likely state based on a behavior of the vehicle with respect to a lane during traveling.

Further, the three or more detection units may further include an eye opening detection unit configured to detect the likely state based on an eye-open state of the eyes of the driver.

According to another illustrative aspect of the present disclosure, provided is a driving assistance system including: a detection device configured to detect a likely state in which likelihood that a driver of a vehicle is dozing is high by different indices and at prescribed intervals; a warning device; and a control device, wherein the detection device includes at least three of: a first detection device configured to detect the likely state based on an eye-closed state of eyes of the driver; a second detection device configured to detect the likely state based on a ratio of a time rate at which an eye opening degree of the driver is equal to or less than a predetermined value; a third detection unit configured to detect the likely state based on an eye-open state of the eyes of the driver; and a fourth detection device configured to detect the likely state based on a behavior of the vehicle with respect to a lane during traveling, and wherein the control device includes: a processor; and a memory storing instructions, the instructions, when executed by the processor, causing the control device to perform: determining that the driver is in a dozing state when the likely state is detected by at least two of the detection devices; and issuing a warning by the warning device based on determining that the driver is in the dozing state.

### Advantageous Effects of Invention

According to the present disclosure, it is possible to prevent an erroneous warning caused by erroneous determination on a dozing state.

### BRIEF DESCRIPTION OF DRAWINGS

FIG. 1 is a schematic diagram showing a configuration of a driving assistance device 1 according to an embodiment of the present disclosure.

FIG. 2 shows a table showing an example of detection results.

FIG. 3 is a table in which the detection results of FIG. 2 are integrated with coefficients.

FIG. 4 is a flowchart showing an example of a dozing warning processing.

### DESCRIPTION OF EMBODIMENTS

<Configuration of Driving Assistance Device>

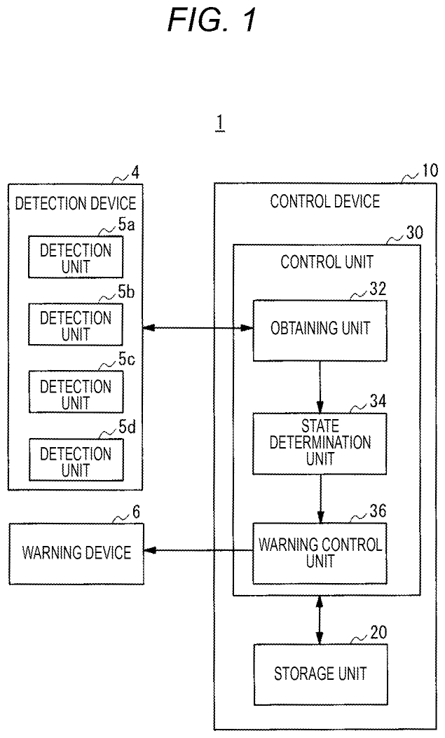

A configuration of a driving assistance device according to an embodiment of the present disclosure will be described with reference to FIG. 1.

FIG. 1 is a schematic diagram showing a configuration of a driving assistance device 1 according to one embodiment.

The driving assistance device 1 is mounted on a vehicle such as a truck, for example, and assists a driver in driving the vehicle. As shown in FIG. 1, the driving assistance device 1 includes a detection device 4, a warning device 6, and a control device 10.

The detection device 4 detects a state of the driver during driving. For example, the detection device 4 detects a likely state (likely-to-be-dozing state) in which likelihood that the driver of the vehicle is dozing is high. At this time, the detection device 4 can detect the likely-to-be-dozing state by a plurality of indices.

In the present embodiment, the detection device 4 detects the likely-to-be-dozing state by a plurality of indices, and determined whether the driver is in a dozing state. Accordingly, the dozing state of the driver can be determined with higher accuracy as compare with a case in which the dozing state of the driver is determined by a single index, so that erroneous determination of the dozing state can be prevented.

The detection device 4 includes three or more detection units (here, four detection units 5a, 5b, 5c, and 5d). The four detection units 5a to 5d perform detection at prescribed intervals. The detection units 5a to 5d can independently detect the likely-to-be-dozing state. The detection indexes of the detection units 5a to 5d are different from each other.

In this case, the detection units 5a to 5c detect the likely-to-be-dozing state based on an eye-open state or an eye-closed state of the driver. The detection by the detection units 5a to 5c is performed by focusing on the tendency that a time during which the eyes of the driver are closed tends to be long in the dozing state of the driver.

The detection unit 5a is a closed eye detection unit that detects it as the likely-to-be-dozing state when the driver closes the eyes for a long time. For example, when a state in which the eyes are closed for a certain period of time during a predetermined time (for example, one second in two seconds) continues for two seconds, the detection unit 5a detects it as the likely-to-be-dozing state.

When a time rate at which an eye opening degree is 20% or less within a predetermined time (for example, 30 seconds) is equal to or greater than a predetermined value (for example, 15%), the detection unit 5b detects it as the likely-to-be-dozing state.

The detection unit 5c is an eye opening detection unit that detects the likely-to-be-dozing state based on an average eye opening degree of the driver. For example, when the average eye opening degree is 80% or less in a case where the eye opening degree is 20% or more within a predetermined time (for example, 180 seconds), the detection unit 5c detects it as the likely-to-be-dozing state.

The detection unit 5d is a vehicle behavior detection unit that detects the likely-to-be-dozing state based on a behavior of the vehicle with respect to a lane during traveling. When a driver in the dozing state drives the vehicle, the vehicle is likely to wobble in a traveling lane. Therefore, when the wobble (displacement amount) of the vehicle in the traveling lane is large, the detection unit 5d detects it as the likely-to-be-dozing state. For example, when a state in which the displacement amount in a predetermined time (for example, 10 seconds) is larger than a threshold value (for example, 0.4 m) continues for 30 seconds, the detection unit 5d detects it as the likely-to-be-dozing state.

In the above description, the detection device 4 includes four detection units 5a to 5d, but the present invention is not limited thereto. For example, the detection device 4 may include three detection units. In addition, the likely-to-be-dozing state may be detected by a detection method other than the detection performed by the detection units 5a to 5d described above.

The warning device 6 is a warning unit that issues a warning to the driver. For example, when the driver is in the dozing state, the warning device 6 issues a warning to warn the driver. The warning device 6 may issue a plurality of warnings according to the dozing state of the driver. For example, the warning device 6 issues a first warning in the case of a light dozing state, and issues a second warning with a warning level higher than that of the first warning in the case dozing in an advanced state (seriously or soundly).

The warning device 6 includes, for example, a speaker that makes a sound such as an alarm, a display unit that displays a warning screen, and a vibration generating unit that generates vibration. Note that the warning device 6 may issue a warning by combining at least two of the sound, the display, and the vibration.

The control device 10 controls operations of the detection device 4 and the warning device 6. As will be described in detail later, the control device 10 determines that the driver is in the dozing state when the likely-to-be-dozing state is detected by at least two of the detection units 5a to 5d of the detection device 4 together. When the control device 10 determines that the driver is in the dozing state while the vehicle is traveling, the control device 10 controls the warning device 6 to issue a warning. That is, when it is determined that the probability of the dozing state is high, the control device 10 issues a warning.

As shown in FIG. 1, the control device 10 includes a storage unit 20 and a control unit 30.

The storage unit 20 is, for example, a Read Only Memory (ROM) or a Random Access Memory (RAM). The storage unit 20 stores a program to be executed by the control unit 30 and various types of data. The storage unit 20 also stores information such as threshold values (a first threshold value and a second threshold value, which will be described later) used in the dozing warning processing.

The control unit 30 is, for example, a central processing unit (CPU). The control unit 30 performs the dozing warning processing by executing a program stored in the storage unit 20. As shown in FIG. 1, the control unit 30 functions as an obtaining unit 32, a state determination unit 34, and a warning control unit 36.

The obtaining unit 32 obtains detection results of the detection units 5a to 5d of the detection device 4. That is, the obtaining unit 32 obtains information on the detection of the likely-to-be-dozing state by the detection units 5a to 5d. For example, the obtaining unit 32 obtains, as a detection result, a numerical value 1 from a detection unit by which the likely-to-be-dozing state is detected, and obtains a numerical value 0 from a detection unit by which the likely-to-be-dozing state is not detected.

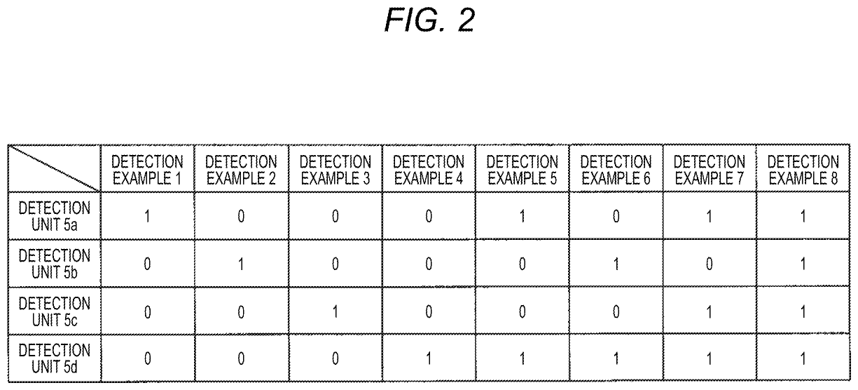

FIG. 2 shows a table showing an example of detection results. In detection examples 1 to 4 shown in FIG. 2, the likely-to-be-dozing state is only detected by one of the four detection units 5a to 5d. For example, in detection example 1, the likely-to-be-dozing state is only detected by the detection unit 5a. In detection example 5, the likely-to-be-dozing state is detected by two detection units 5a and 5d, and in detection example 6, the likely-to-be-dozing state is detected by two detection units 5b and 5d. In detection example 7, the likely-to-be-dozing state is detected by three detection units 5a, 5c, and 5d. In detection example 8, the likely-to-be-dozing state is detected by four detection units 5a to 5d.

The state determination unit 34 determines whether or not the driver is in the dozing state based on the detection results of the detection units 5a to 5d of the detection device 4. That is, the state determination unit 34 determines that the driver is in the dozing state when the likely-to-be-dozing state is detected by at least two detection units of the detection device 4 together, and determines that the driver is not in the dozing state when the likely-to-be-dozing state is detected by only one detection unit. For example, the state determination unit 34 determines that the driver is not in the dozing state in detection examples 1 to 4 shown in FIG. 2, and determines that the driver is in the dozing state in detection examples 5 to 8 shown in FIG. 2.

The state determination unit 34 may sum up numerical values indicating detection of the likely-to-be-dozing state by the detection units 5a to 5d, and determine that the driver is in the dozing state when a total value exceeds the first threshold value. For example, it is assumed that a numerical value when the likely-to-be-dozing state is detected is 1, a numerical value when the likely-to-be-dozing state is not detected is 0, and the first threshold value is 1.9. Accordingly, the state determination unit 34 can easily and accurately determine the dozing state based on the total value of the detection results of the four detection units 5a to 5d.

The state determination unit 34 may integrate coefficients with the detection results (numerical values of 1 or 0) of the four detection units 5a to 5d respectively to obtain a total value. For example, the state determination unit 34 integrates a coefficient a (0.9) with the detection result of the detection unit 5a, integrates a coefficient b (0.9) with the detection result of the detection unit 5b, integrates a coefficient c (0.8) with the detection result of the detection unit 5c, and integrates a coefficient d (1.0) with the detection result of the detection unit 5d. As a result, the detection results of the four detection units 5a to 5d are weighted. The coefficients a to d may be values other than those described above.

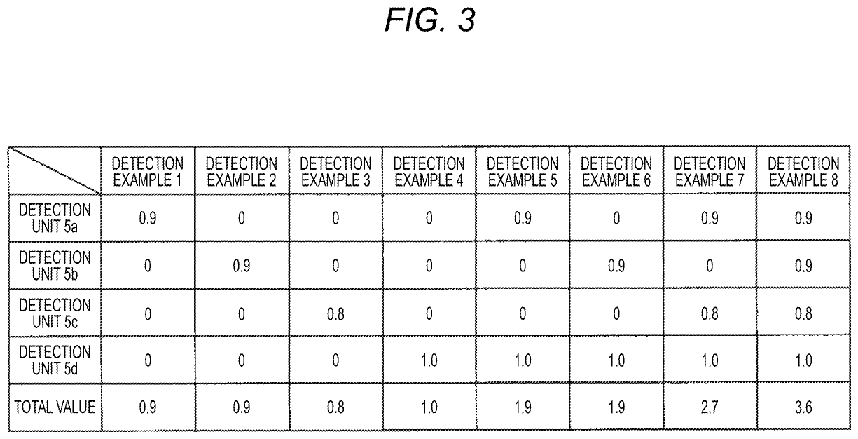

FIG. 3 is a table in which the detection results of FIG. 2 are integrated with coefficients. In detection examples 1 to 4 shown in FIG. 3, since total values are smaller than the first threshold value (1.9), the state determination unit 34 determines that the driver is not in the dozing state. On the other hand, in detection examples 5 to 8, since total values are equal to or greater than the first threshold value (1.9), the state determination unit 34 determines that the driver is in the dozing state. In the case of detection example 8, the state determination unit 34 determines that the total value is equal to or greater than the second threshold value (2.9).

Although not shown in the detection examples of FIG. 3, when the likely-to-be-dozing state is detected by the detection units 5a and 5b, a total value is 1.8, which is smaller than the first threshold value (1.9). Therefore, when the likely-to-be-dozing state is detected by only the detection units 5a and 5b, it is determined that the driver is not in the dozing state.

Further, the coefficients may vary depending on a driving state of the vehicle. For example, in a state where the driver drives the vehicle, the coefficients a to d of the above-described values are used, and in a lane keeping mode in which a lane in which the vehicle travels is maintained, values of the coefficients a to d are made different. As an example, the coefficient a is set to 1.0, the coefficient b is set to 0.9, the coefficient c is set to 0.8, and the coefficient d is set to 0.

The warning control unit 36 controls an operation of the warning device 6. That is, when the state determination unit 34 determines that the driver is in the dozing state, the warning control unit 36 controls the warning device 6 to issue a warning. For example, when the total value reflecting the coefficients exceeds the first threshold value, the warning control unit 36 controls the warning device 6 to issue a warning.

The warning control unit 36 may control to issue the first warning or the second warning according to the magnitude of the total value. For example, when the total value reflecting the coefficients exceeds the first threshold value (1.9), the warning control unit 36 controls to issue the first warning. When the total value reflecting the coefficients exceeds the second threshold value (2.9), the warning control unit 36 controls to issue the second warning. When the total value is large, there is a high possibility that the dozing state of the driver is serious. Therefore, it is possible to call attention to the driver by issuing the second warning with a higher warning level.

<Dozing Warning Processing>

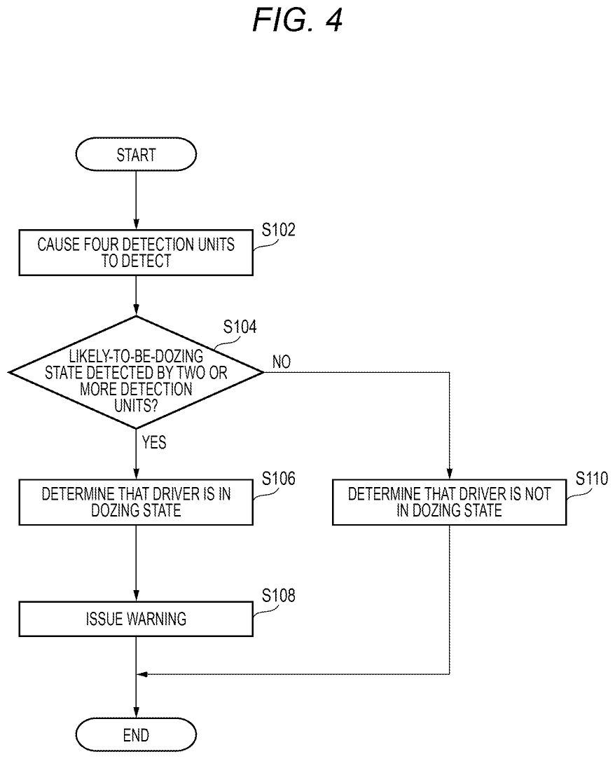

A flow of the dozing warning processing will be described with reference to FIG. 4. FIG. 4 is a flowchart showing an example of the dozing warning processing.

The dozing warning processing shown in FIG. 4 is performed while the vehicle is traveling.

First, the control device 10 causes the four detection units 5a to 5d of the detection device 4 to detect whether or not the driver is in the likely-to-be-dozing state (step S102). The detection units 5a to 5d continuously perform detection at prescribed intervals. The obtaining unit 32 of the control device 10 sequentially obtains detection results of the detection units 5a to 5d.

Next, the state determination unit 34 determines whether or not the likely-to-be-dozing state is detected by two or more of the four detection units 5a to 5d (step S104). When the likely-to-be-dozing state is detected by two or more detection units in step S104 (Yes), the state determination unit 34 determines that the driver is in the dozing state (step S106). For example, when the total value of the numerical values indicating the detection by the detection units 5a to 5d exceeds the first threshold value, the state determination unit 34 determines that the driver is in the dozing state.

When it is determined that the driver is in the dozing state, the warning control unit 36 controls the warning device 6 to issue a warning (step S108). At this time, the warning control unit 36 controls to issue the first warning when the total value exceeds the first threshold value, and issue the second warning when the total value exceeds the second threshold value.

When the likely-to-be-dozing state is detected by only one detection unit in step S104 (No), the state determination unit 34 determines that the driver is not in the dozing state (step S110). In this case, the warning control unit 36 controls the warning device 6 not to issue a warning.

<Effect of Present Embodiment>

The driving assistance device 1 described above includes three or more detection units (for example, detection units 5a to 5d) that detect a likely-to-be-dozing state by different indices. When the likely-to-be-dozing state is detected by at least two detection units together, the driving assistance device 1 determines that the driver is in the dozing state, and controls the warning device 6 to issue a warning.

Accordingly, it is possible to determine the dozing state with higher accuracy as compared with a case in which the dozing state is determined by only a single index. As a result, it is possible to prevent issuance of an erroneous alarm of the warning device 6 due to an erroneous determination.

The present invention has been described using the embodiment, but the technical scope of the present invention is not limited to the scope described in the embodiment described above, and various modifications and changes can be made within the scope thereof. For example, all or some of the devices may be functionally or physically distributed or integrated in any unit. Further, new embodiments generated by any combination of a plurality of embodiments are also contained in the embodiment of the present invention. Effects of the new embodiment generated by the combination include effects of the original embodiment.

The present application is based on the Japanese Patent Application No. 2020-26463 filed on Feb. 19, 2020, and contents thereof are incorporated herein as reference.

### INDUSTRIAL APPLICABILITY

The present invention has an effect of preventing an erroneous warning caused by erroneous determination on a dozing state, and is useful for a driving assistance device, a driving assistance system, and the like.

### REFERENCE SIGNS LIST

1 Driving assistance device
5a to 5d Detection unit
6 Warning device
34 State determination unit
36 Warning control unit

1. A driving assistance device comprising:
three or more detection devices configured to detect a likely state in which likelihood that a driver of a vehicle is dozing is higher than a threshold by different indices and at prescribed intervals; and
a control device configured to:
determine that the driver is in a dozing state when the likely state is detected by at least two of the detection units; and
control a warning device to issue a warning in a case it is determined that the driver is in the dozing state.

2. The driving assistance device according to claim 1, wherein in the determining, the control device is configured to:
totalize numerical values indicating detection of the likely state by each of the detection devices; and
in a case a total value exceeds a threshold value, determine that the driver is in the dozing state.

3. The driving assistance device according to claim 2, wherein in the controlling of the warning device, the control device is configured to:
in a case the total value exceeds a first threshold value, control the warning device to issue a first warning; and
in a case the total value exceeds a second threshold value larger than the first threshold value, control the warning device to issue a second warning with a warning level higher than that of the first warning.

4. The driving assistance device according to claim 1, wherein the three or more detection devices include:
a first detection device configured to detect the likely state based on an eye-closed state of eyes of the driver; and
a second detection device configured to detect the likely state based on a behavior of the vehicle with respect to a lane during traveling.

5. The driving assistance device according to claim 4, wherein the three or more detection devices further include a third detection device configured to detect the likely state based on an eye-open state of the eyes of the driver.

6. A driving assistance system comprising:
a detection device configured to detect a likely state in which likelihood that a driver of a vehicle is dozing is higher than a threshold by different indices and at prescribed intervals;
a warning device; and
a control device,
wherein the detection device includes at least three of:
a first detection device configured to detect the likely state based on an eye-closed state of eyes of the driver;
a second detection device configured to detect the likely state based on a ratio of a time rate at which an eye opening degree of the driver is equal to or less than a predetermined value;
a third detection device configured to detect the likely state based on an eye-open state of the eyes of the driver; and
a fourth detection device configured to detect the likely state based on a behavior of the vehicle with respect to a lane during traveling, and
wherein the control device comprises:
a processor; and
a memory storing instructions, the instructions, when executed by the processor, causing the control device to perform:
determining that the driver is in a dozing state when the likely state is detected by at least two of the detection devices; and
issuing a warning by the warning device based on determining that the driver is in the dozing state.
